(19) United States
(12) Patent Application Publication
(10) Pub. No.: US 2019/0147365 A1
(43) Pub. Date: May 16, 2019

(54) DEEP VECTOR TABLE MACHINE SYSTEMS

(71) Applicant: Google Inc., Mountain View, CA (US)

(72) Inventor: Jay Yagnik, Mountain View, CA (US)

(21) Appl. No.: 14/830,579

(22) Filed: Aug. 19, 2015

Related U.S. Application Data
(60) Provisional application No. 62/039,054, filed on Aug. 19, 2014.

(51) Int. Cl. G06N 99/00

(52) U.S. Cl. CPC G06N 99/005

(57) ABSTRACT

Methods, systems, and apparatus, including computer programs encoded on computer storage media, for generating outputs from received inputs using deep vector table machine (VTM) systems. One of the methods includes receiving an input; processing the input through each of a plurality of VTM layers to generate an alternative representation of the input, wherein the plurality of VTM layers are arranged in a sequence from a lowest VTM layer to a highest VTM layer, and wherein each VTM layer is configured to: receive an input representation of the input, generate a sparse representation of the input representation in accordance with a set of sparse parameter vectors for the VTM layer, and generate an output representation from the sparse representation in accordance with a set of output parameter vectors for the VTM layer; and processing the alternative representation of the input through an output layer to generate an output for the input.

### CROSS-REFERENCE TO RELATED APPLICATION

This application claims priority to U.S. Provisional Application No. 62/039,054, filed on Aug. 19, 2014. The disclosure of the prior application is considered part of and is incorporated by reference in the disclosure of this application.

### BACKGROUND

This specification relates to an architecture for a deep machine learning model.

Deep machine learning models are machine learning models that employ multiple layers of models to predict an output for a received input. For example, a deep neural network includes an output layer and one or more hidden layers that each apply a non-linear transformation to a received input to generate an output.

### SUMMARY

This specification describes technologies that relate to deep vector table machine (VTM) systems. In general, a deep VTM system includes a set of VTM layers and an output layer. Each input received by the deep VTM system is processed through the VTM layers to generate an alternative representation of the input and then processed through the output layer to generate an output for the received input. Each of the VTM layers is configured to receive an input representation, generate a sparse representation of the input representation in accordance with a set of sparse parameter vectors for the VTM layer, and generate an output representation from the sparse representation in accordance with a set of output parameter vectors for the VTM layer.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. Machine learning systems that include multiple vector table machine (VTM) layers can be both deep and sparse. Machine learning systems including VTM layers can be trained more efficiently and quickly than systems of comparable size that include conventional layers, e.g., deep neural networks. By reducing the training time, larger machine learning systems can be trained efficiently, improving the performance of the trained system.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example deep Vector Table Machine (VTM) system.

FIG. 2 is a flow diagram of an example process for generating an output from a received input.

FIG. 3 is a flow diagram of an example process for generating an output representation from a received input representation.

FIG. 4 shows an example process for generating a sparse representation of an input representation using a VTM layer that has partitioned sparse parameter vectors.

FIG. 5 is a flow diagram of an example process for generating a sparse representation of an input representation using a VTM layer that has sparse parameter vectors arranged in a hierarchical tree.

FIG. 6 is a flow diagram of an example process for generating a sparse representation of an input representation using an optimization.

FIG. 7 shows an example system for training a machine learning system that includes VTM layers.

Like reference numbers and designations in the various drawings indicate like elements.

### DETAILED DESCRIPTION

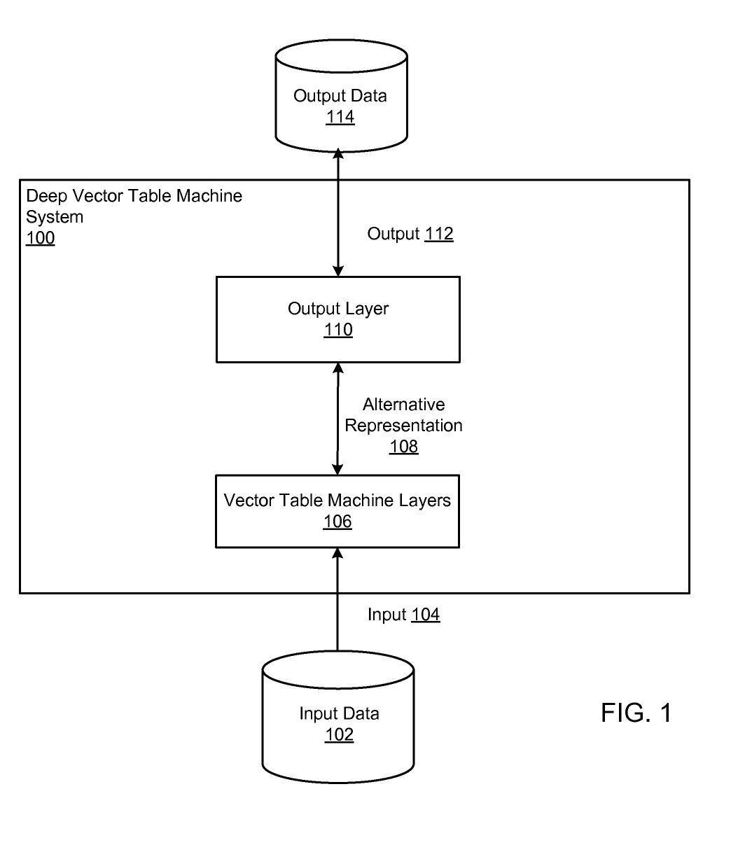

FIG. 1 shows an example deep Vector Table Machine (VTM) system 100. The deep VTM system 100 is an example of a system implemented as computer programs on one or more computers in one or more locations, in which the systems, components, and techniques described below are implemented.

The deep VTM system 100 is a machine learning system that receives an input, e.g., an input 104 from an input data repository 102, and generates an output from the input, e.g., an output 112 generated by the deep VTM system 100 from the input 104. The deep VTM system 100 can store the generated output in an output data repository 114 or provide the output for use for some other immediate purpose.

The deep VTM system 100 can be configured to receive any kind of digital data input and to generate any kind of score or classification output based on the input. For example, if the inputs to the deep VTM system 100 are images or features that have been extracted from images, the output generated by the deep VTM system 100 for a given image may be scores for each of a set of object categories, with each score representing an estimated likelihood that the image contains an image of an object belonging to the category. As another example, if the inputs to the deep VTM system 100 are Internet resources (e.g., web pages), documents, or portions of documents or features extracted from Internet resources, documents, or portions of documents, the output generated by the deep VTM system 100 for a given Internet resource, document, or portion of a document may be a score for each of a set of topics, with each score representing an estimated likelihood that the Internet resource, document, or document portion is about the topic. As another example, if the inputs to the deep VTM system 100 are features of an impression context for a particular advertisement, the output generated by the deep VTM system 100 may be a score that represents an estimated likelihood that the particular advertisement will be clicked on. As another example, if the inputs to the deep VTM system 100 are features of a personalized recommendation for a user, e.g., features characterizing the context for the recommendation, e.g., features characterizing previous actions taken by the user, the output generated by the deep VTM system 100 may be a score for each of a set of content items, with each score representing an estimated likelihood that the user will respond favorably to being recommended the content item. As another example, if the input to the deep VTM system 100 is text in one language, the output generated by the deep VTP system 100 may be a score for each of a set of pieces of text in another language, with each score representing an estimated likelihood that the piece of text in the other language is a proper translation of the input text into the other language. As another example, if the input to the deep VTM system 100 is a spoken utterance, a sequence of spoken utterances, or features derived from one of the two, the output generated by the deep VTM system 100 may be a score for each of a set of pieces of text, each score representing an estimated likelihood that the piece of text is the correct transcript for the utterance or sequence of utterances.

In particular, the deep VTM system 100 includes VTM layers 106 and an output layer 110. The VTM layers 106 are arranged in a sequence from a lowest VTM layer in the sequence to a highest VTM layer in the sequence. The deep VTM system 100 processes the received input through each VTM layer in the sequence to generate an alternative representation of the input, e.g., an alternative representation 108 of the input 104, and processes the alternative representation through the output layer 110 to generate the output for the input from the alternative representation, e.g., the output 112 from the alternative representation 108. As used in this specification, a “representation” is a collection of numeric values. Generally, the collection will be an ordered collection of floating point values or of quantized integer values whose encoding represents floating point values. For example, a representation may be an ordered array or vector of the numeric values.

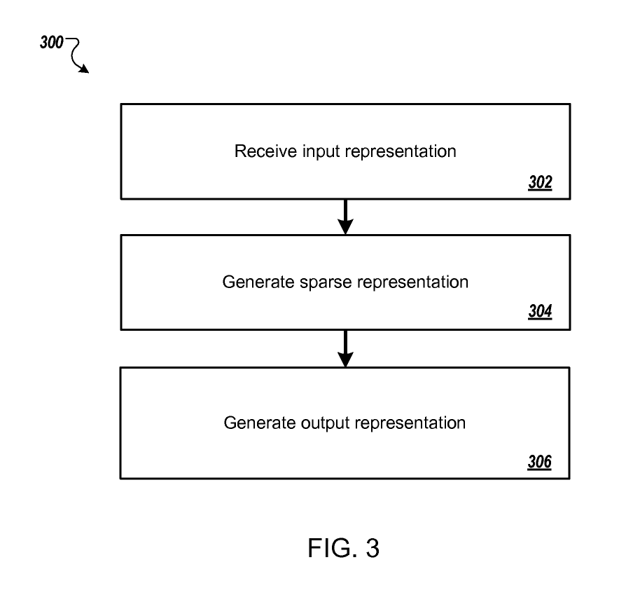

Each of the VTM layers 106 receives an input representation and generates an output representation from the input representation in accordance with two sets of parameter vectors: a set of sparse parameter vectors and a set of output parameter vectors. In particular, each VTM layer generates a sparse representation of the input representation in accordance with the set of sparse parameter vectors for the layer. The VTM layer then generates an output representation from the sparse representation in accordance with the output parameter vectors for the layer. Generating sparse and output representations will be described in more detail below with reference to FIGS. 3-5. While the parameter vectors are referred to in this specification as vectors, any appropriate representation of a collection of ordered values can be used.

Once the VTM layer has generated the output representation, the deep VTM system 100 provides the output representation to a next VTM layer in the sequence or, if the VTM layer is the highest layer in the sequence, to the output layer 110 as the alternative representation of the input. Optionally, prior to providing the output representation as input to the next VTM layer in the sequence, the deep VTM system 100 can apply a transformation to the output representation, e.g., by processing the output representation through a regularization layer or a max pooling layer.

The output layer 110 receives the alternative representation of the input generated by the VTM layers 106 and generates an output from the alternative representation. Depending on the context of use for the deep VTM system 100, the output layer 110 can be any of a variety of conventional output layers. For example, if the deep VTM system 100 is configured to generate a score for each of a set of categories, e.g., object categories or resource types, the output layer 110 can be a conventional multiclass or multilabel classifier that receives the alternative representation and generates the scores, e.g., a multiclass logistic regression classifier, a multiclass support vector machine classifier, a Bayesian classifier, and so on. As another example, if the deep VTM system 100 is configured to rank the categories in the set of categories, the output layer 110 can be a conventional ranking function layer that orders the concept terms based on the alternative representation using a ranking function, e.g., a hinge-loss ranking function, a pairwise ranking function, and so on. As another example, if the deep VTM system 100 is configured to generate a single score, e.g., a score that represents the likelihood that a user will click on an advertisement, the output layer 110 can be a single class classifier that receives the alternative representation and generates the score, e.g., a logistic regression classifier.

In some implementations, the deep VTM system 100 also includes other types of layers. In particular, the deep VTM system 100 may include layers that apply a transformation to inputs received by the layer but do not have parameters, e.g., max pooling or regularization layers. As another example, the other layers can include layers that have parameters, e.g., convolutional layers, fully-connected layers, or other types of neural network layers that apply a transformation to a received input in accordance with current values of the parameters for the layer.

Additionally, in some implementations, the deep VTM system 100 includes recurrent connections, long short term memory (LSTM) connections, or both, between the VTM layers 106.

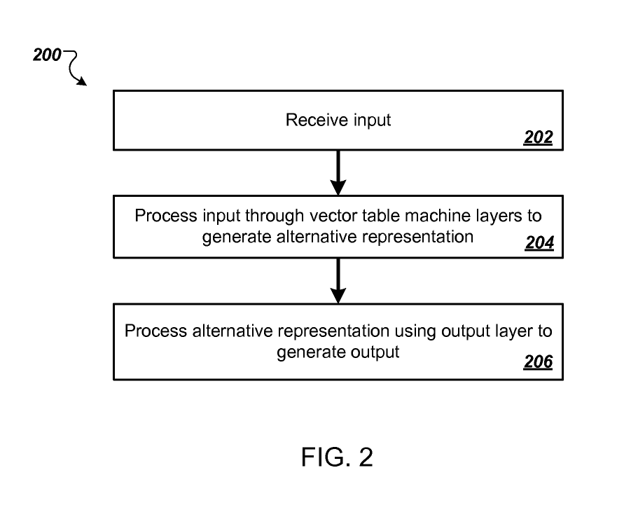

FIG. 2 is a flow diagram of an example process 200 for generating an output from a received input. For convenience, the process 200 will be described as being performed by a system of one or more computers located in one or more locations. For example, a deep VTM system, e.g., the deep VTM system 100 of FIG. 1, appropriately programmed in accordance with this specification, can perform the process 200.

The system receives an input (step 202).

The system processes the received input through a sequence of VTM layers to generate an alternative representation of the input (step 204). In particular, each VTM layer in the set of VTM layers generates a sparse representation of the input representation in accordance the set of sparse parameter vectors for the layer. The VTM layer then generates an output representation from the sparse representation in accordance with the output parameter vectors for the layer. The system then provides the output representation generated by the VTM layer as input to the next VTM layer in the sequence or, if the VTM layer is the last layer in the sequence, treats the output representation as the alternative representation of the input. Optionally, prior to providing an output representation as input to the next VTM layer in the sequence or treating the output representation as the alternative representation, the system applies a transformation to the output representation, e.g., by processing the output representation through a regularization layer or a max-pooling layer.

The system processes the alternative representation through an output layer to generate an output from the received input (step 206). The output generated by the output layer from the alternative representation generally depends on the context of use of the system. For example, if the output layer is a logistic regression classifier, the output can be a single score representing a particular likelihood or, if the output layer is a multiclass or multi-category classifier, the output can be a set of scores, each representing a different likelihood.

FIG. 3 is a flow diagram of an example process 300 for generating an output representation from a received input representation. For convenience, the process 300 will be described as being performed by a system of one or more computers located in one or more locations. For example, a deep VTM system, e.g., the deep VTM system 100 of FIG. 1, appropriately programmed in accordance with this specification, can perform the process 200.

The process 300 can be performed by each VTM layer of a set of VTM layers, e.g., each of the VTM layers 106 of the deep VTM system 100 of FIG. 1, in sequence in order to generate an alternative representation of an input received by the system.

The system receives an input representation (step 302). For the lowest layer in the sequence of VTM layers, the input representation is the input originally received by the system. For each other layer in the sequence, the input representation is an output representation generated by the preceding VTM layer in the sequence or by another layer interspersed among the VTM layers in the sequence, e.g., a regularization or max-pooling layer.

The system generates a sparse representation of the input representation in accordance with a set of sparse parameter vectors for the VTM layer (step 304). In particular, the system applies a sparsifying function to the input representation that maps the input representation into a representation that has the same dimensionality, i.e., includes the same number of numeric values, as the number of vectors in the sparse parameter vectors for the VTM layer and that is a sparse representation in accordance with the set of sparse parameter vectors. Generally, a representation is a sparse representation if only a small subset of the values in the representation are non-zero. For example, a representation may be considered sparse if less than twenty-five percent of the values in the representation are non-zero. In some implementations, the sparse representations generated by the VTM layers of the system are very sparse representations that have less than one percent non-zero values.

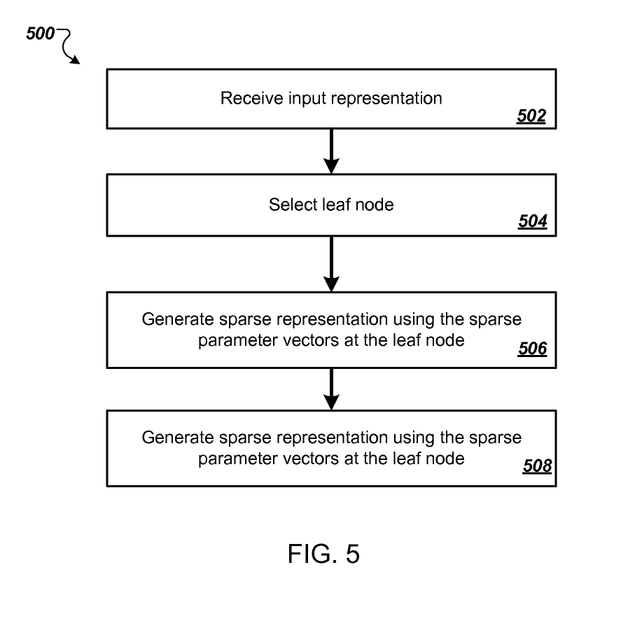

In some implementations, the sparsifying function is a reconstructive function that maps the input representation into a sparse representation that, when combined with the sparse parameter vectors, best reconstructs the input representation. For example, the sparse representation a may satisfy:

$$α = {min}_{α} {\vert x - {\sum }_{i} {α}_{i} {q}_{i} \vert}^{2} + λ {\vert α \vert}_{1} ,$$

where x is the input representation, the sum is over the total number of sparse parameter vectors, αᵢ is the value of the i-th dimension of the sparse representation, qᵢ is the i-th sparse parameter vector, λ is a constant value, and |α|₁ is the L¹-norm of α. In some implementations, the system optimizes the computation of the sparse representation by first determining the k-nearest neighbors to the input representation among the sparse parameter vectors. Optimizing the computation of the sparse representation is described in more detail below with reference to FIG. 5.

The system generates an output representation of the sparse representation in accordance with a set of output parameter vectors for the VTM layer (step 306). In particular, the system applies an output function to the sparse representation that maps the sparse representation into the output representation in accordance with the set of output parameter vectors. For example, the output y may satisfy:

$$y = {\sum }_{i} {α}_{i} {t}_{i} ,$$

where the sum is a sum over the dimensions of the sparse representation, αᵢ is the value of the i-th dimension of the sparse representation, and tᵢ is the i-th output parameter vector. As another example, some VTM layers may use the sparse representation generated by the layer to predict LSTM gates. LSTM gates are described in more detail in Supervised Sequence Labeling with Recurrent Neural Networks, Alex Graves, Technical University of Munich, 2008, pages 32-39 of which describe LSTM gates, and which description of LSTM gates is hereby incorporated by reference herein.

In some implementations, the sparse parameter vectors for a given VTM layer are partitioned into blocks. In these implementations, each input representation can be routed to one of the blocks before the sparsifying function is applied to the input representation.

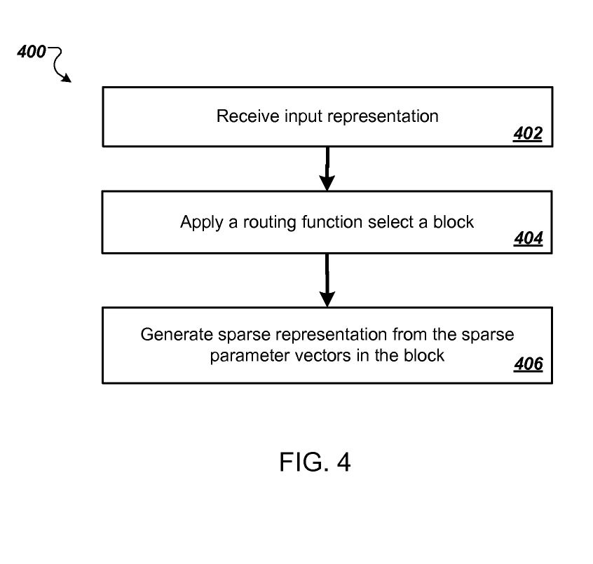

FIG. 4 is a flow diagram of an example process 400 for generating a sparse representation of an input representation using a VTM layer that has partitioned sparse parameter vectors. For convenience, the process 400 will be described as being performed by a system of one or more computers located in one or more locations. For example, a deep VTM system, e.g., the deep VTM system 100 of FIG. 1, appropriately programmed in accordance with this specification, can perform the process 400.

The system receives an input representation (step 402).

The system applies a routing function to select one of the blocks of sparse parameter vectors (step 404). That is, the system applies a routing function to the input representation that maps the input representation to one of the blocks of sparse parameter vectors for the VTM layer.

In some implementations, the routing function does not have parameters that are adjusted during training of the VTM layers. For example, the routing function may be a function that compares the input representation to a respective representation derived from the sparse parameter vectors in each block and selects a block based on the results of the comparison. The representation derived from the sparse parameter vectors in a given block may be, e.g., an average measure or a norm measure of the vectors in the block. The system can compare the input representation to the representations derived from the blocks and select, e.g., the block that has a representation that is most similar to, e.g., that has the largest similarity measure, e.g., a largest cosine similarity measure, with the input representation.

In some other implementations, the routing function has parameters whose values are adjusted during training of the VTM layers. For example, the routing function can be associated with a respective parameter vector for each block. The routing function can then compute a similarity measure between the input representation and the respective parameter vector for each block, with the value of the similarity measure representing the likelihood that the corresponding block is selected. In some implementations, the routing function selects the block having the highest similarity measure value. In some other implementations, the routing function samples from the blocks in accordance with the corresponding similarity measure values.

The system generates a sparse representation from the input representation using the sparse parameter vectors in the block (step 406). That is, the system applies the sparsifying function to map the input representation to the sparse representation in accordance with the sparse parameter vectors in the block. For example, if the sparsifying function is a reconstructive function, the system may apply the reconstructive function with the constraint that, for each dimension of the sparse representation that does not correspond to a sparse parameter vector in the block, the value of that dimension of the sparse representation must be zero. That is, the system uses only the sparse parameter vectors in the block in determining the sparse representation that best reconstructs the input representation.

In some implementations, the sparse parameter vectors for a given VTM layer are arranged in a hierarchical tree, with each node in the tree having one or more sparse parameter vectors. In these implementations, the sparse parameter vectors at each leaf node in the hierarchical tree are associated with one or more output parameter vectors.

FIG. 5 is a flow diagram of an example process 500 for generating a sparse representation of an input representation using a VTM layer that has sparse parameter vectors arranged in a hierarchical tree. For convenience, the process 500 will be described as being performed by a system of one or more computers located in one or more locations. For example, a deep VTM system, e.g., the deep VTM system 100 of FIG. 1, appropriately programmed in accordance with this specification, can perform the process 500.

The system receives an input representation (step 502).

The system selects a leaf node of the hierarchical tree (step 504). That is, the system traverses the tree to select a leaf node of the tree to which the route the input representation. For example, the system can search the tree using a near-neighbor search technique in the tree to determine the leaf node that is closest to the input representation. That is, at each split in the tree, the system compares the input representation to the sparse parameter vectors at the branches of the split in order to select a branch. For example, the system can apply a routing function at each split, e.g., as described above with reference to FIG. 4.

The system generates a sparse representation of the input representation using the sparse parameter vectors at the selected leaf node (step 506).

The system generates an output representation from the sparse representation using the output parameter vectors associated with the sparse parameter vectors at the selected leaf node (step 508).

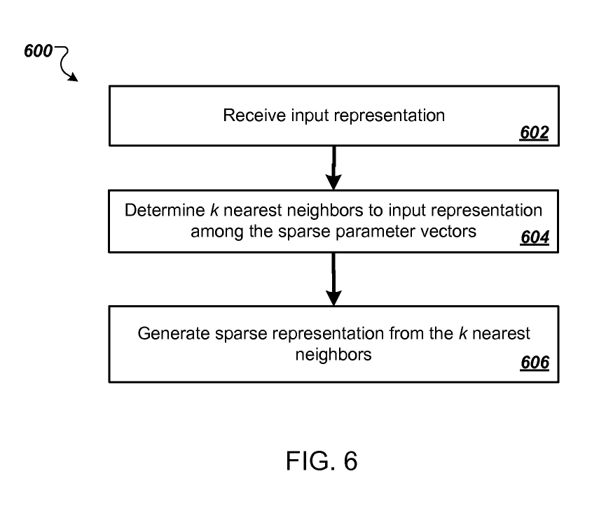

FIG. 6 is a flow diagram of an example process 600 for generating a sparse representation of an input representation using an optimization. For convenience, the process 600 will be described as being performed by a system of one or more computers located in one or more locations. For example, a deep VTM system, e.g., the deep VTM system 100 of FIG. 1, appropriately programmed in accordance with this specification, can perform the process 600.

The system receives an input representation (step 602).

The system determines the k nearest neighbors to the input representation among the sparse parameter vectors, where k is a positive integer (step 604). The value of k can be determined based on the number of parameter vectors for the VTM layer, e.g., the integer closest to a pre-determined proportion, e.g., 0.05%, 0.5%, 0.75%, 1%, or 2%, of the number of parameter vectors for the layer. For example, the system can determine the k nearest neighbors to the input representation under the dot product distance operation using any of a variety of conventional techniques. For example, the system can determine the k nearest neighbors using a locality sensitive hashing (LSH) technique.

The system generates the sparse representation from the k nearest neighbors (step 606). That is, the system determines a sparse representation that best reconstructs the input representation, with the constraint that the value of each dimension of the sparse representation that does not correspond to one of the k nearest neighbors must be zero. For example, the sparse representation α may satisfy:

$$α = {min}_{α} {\vert {x}^{p} - {\sum }_{i} {α}_{i} {q}_{i} \vert}^{2} ,$$

given the constraint that, if the sparse parameter vector i is not among the k nearest neighbors to the input representation x, the value of i-th component of α(α) must be zero. By optimizing the computation of the sparse representation of the input representation using the process 600, the desired degree of sparsity of the sparse representation can be guaranteed, i.e., by ensuring that only k dimensions of the sparse representations can take non-zero values.

The processes 200, 300, 400, 500, and 600 can be performed to generate an output for an input for which the desired output, i.e., the output that should be generated by the system for the input, is not known. The processes 200, 300, 400, 500, and 600 can also be performed on inputs in a set of training data, i.e., a set of inputs for which the output that should be predicted by the system is known, in order to train the system, i.e., to determine trained values for the sparse parameter vectors and the output parameter vectors of the VTM layers. In particular, the processes 200, 300, 400, 500, and 600 can be performed repeatedly on inputs selected from a set of training data as part of a stochastic gradient descent backpropagation training technique that determines trained values for each of the parameter vectors of the VTM layers.

Prior to training, the system selects initial values for the parameter vectors of each VTM layer. In some implementations, the system selects the initial values randomly. In some other implementations, however, the system selects the initial values of the sparse parameter vectors for the lowest VTM layer in the sequence of layers by randomly sampling from the training inputs in the set of training data, i.e., so that the value of each initial sparse parameter vector for the lowest VTM layer is a randomly sampled input from the set of training data. Furthermore, in some implementations, if the sparse representation generated by a given VTM layer is the same dimensionality as the output representation generated by the preceding VTM layer in the sequence, the system selects the initial value of the sparse parameter vectors for the given VTM layer to be the same as the initial values of the output parameter vectors for the preceding VTM layer.

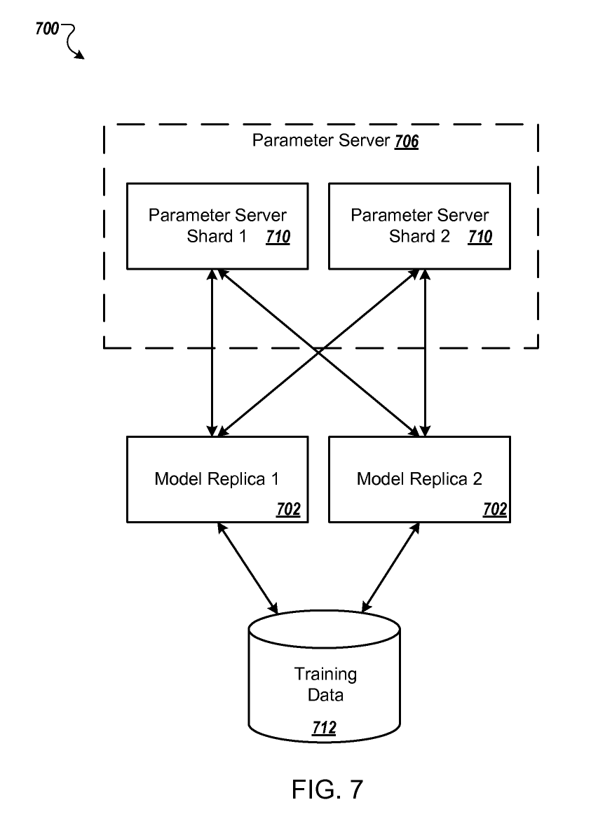

FIG. 7 shows an example system 700 for training a machine learning system that includes VTM layers, e.g., the deep VTM system 100 of FIG. 1.

The machine learning system can be trained using training data, i.e., the training data in training data database 112. The training data in the training data database 112 are inputs for which the desired output, i.e., the output that should be generated by the machine learning system, is known. In order to train the machine learning system, i.e., find trained values of the sparse parameter vectors and the output parameter vectors of the VTM layers of the machine learning system, an objective function is developed that is a measure of the performance of the machine learning system on the set of training data as a function of the parameter vectors. The trained values of the parameter vectors of the model can then be found by finding a minimum of the objective function. In particular, multiple iterations of a stochastic gradient descent procedure can then be performed to find the trained values of the parameter vectors.

The example system 700 includes multiple model replicas 702. Each of the model replicas 702 is an identical instance of a deep VTM system, e.g., the deep VTM system 100 of FIG. 1, and can be implemented as one or more computer programs and data deployed to be executed on a computing unit. Advantageously, the computing units are configured so that they can operate independently of each other. In some implementations, only partial independence of operation is achieved, for example, because replica instances share some resources.

A computing unit may be, e.g., a computer, a core within a computer having multiple cores, or other hardware or software within a computer capable of independently performing the computation for the model replica. Each model replica 702 operates independently from each of the other model replicas 702 and is configured to communicate with the training data database 712 and a parameter server 706 through a network, e.g., a local area network (LAN) or wide area network (WAN), e.g., the Internet, in order to compute delta values for the parameter vectors of the VTM layers of the deep VTM system. A delta value for a parameter is a value that the replica has determined is to be applied to the current value of the parameter so that it approaches its trained value.

The parameter server 706 maintains the current values of the parameter vectors of the VTM layers and updates the values as the results of training are uploaded by the replicas. The functionality of the parameter server 706 is partitioned among multiple parameter server shards 710. That is, each of the parameter server shards 710 maintains values of a respective subset of the parameters of the VTM layers, such that the parameters of the VTM layers are partitioned among the parameter server shards 710. Each parameter server shard 710 is implemented on a respective independent computing unit. Advantageously, the computing units are configured so that they can operate independently of each other. In some implementations, only partial independence of operation is achieved, for example, because replica instances share some resources.

Each of the parameter server shards 710 provides values of parameters to the model replicas 702, receives delta values of the parameters from the model replicas 702, and updates stored values of the parameters based on the received delta values independently from each other parameter server shard. Computer-implemented methods for training a machine learning model, and in particular a deep machine learning model, are described in more detail in U.S. Pat. No. 8,768,870, issued on Jul. 1, 2014, the entire contents of which are hereby incorporated by reference herein. These methods can be used to train a deep VTM system using the system 700.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a relationship graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving an input;
processing the input through each of a plurality of vector table machine (VTM) layers to generate an alternative representation of the input, wherein the plurality of VTM layers are arranged in a sequence from a lowest VTM layer to a highest VTM layer, and wherein each VTM layer is configured to:
receive an input representation of the input,
generate a sparse representation of the input representation in accordance with a set of sparse parameter vectors for the VTM layer, and
generate an output representation from the sparse representation in accordance with a set of output parameter vectors for the VTM layer; and
processing the alternative representation of the input through an output layer to generate an output for the input.

2. The method of claim 1, wherein generating the output representation comprises:
generating the output representation by applying an output function to the sparse representation that maps the sparse representation to the output representation in accordance with the set of output parameter vectors.

3. The method of claim 2, wherein the output representation y satisfies:
$$y = {\sum }_{i} {α}_{i} {t}_{i} ,$$
wherein the sum is a sum over the dimensions of the sparse representation, αᵢ is a value of an i-th dimension of the sparse representation, and tᵢ is the i-th output parameter vector.

4. The method of claim 1, wherein generating the sparse representation comprises:
generating the sparse representation of the input representation by applying a sparsifying function to the input representation that maps the input representation to the sparse representation in accordance with the set of sparse parameter vectors.

5. The method of claim 4, wherein the sparsifying function is a reconstruction function that maps the input representation to the sparse representation, that when combined with the sparse parameter vectors, most closely reconstructs the input representation.

6. The method of claim 5, wherein the sparse representation a satisfies:
$$α = {min}_{α} {\vert x - {\sum }_{i} {α}_{i} {q}_{i} \vert}^{2} + λ {\vert α \vert}_{1} ,$$
wherein x is the input representation, the sum is over the total number of sparse parameter vectors, αᵢ is the value of the i-th dimension of the sparse representation, qᵢ is the i-th sparse parameter vector, λ is a constant value, and |α|₁ is the L¹-norm of α.

7. The method of claim 5, wherein determining the sparse representation comprises:
determining the k-nearest neighbors to the input representation among the sparse parameters vectors; and
mapping the input representation to the sparse representation that most closely reconstructs the input representation using the k-nearest neighbors.

8. The method of claim 1, wherein the sparse parameter vectors for the VTM layer are partitioned into blocks, and wherein determining the sparse representation comprises:
applying a routing function to the input representation to select a first block from the blocks; and
generating the sparse representation in accordance with the sparse parameter vectors in the first block.

9. The method of claim 1, wherein the sparse parameter vectors for the VTM layers are arranged in a hierarchical tree, wherein each node of the tree has one or more sparse parameter vectors, and wherein the sparse parameter vectors at each leaf node of the tree is associated with one or more output parameter vectors.

10. The method of claim 9, wherein generating the sparse representation comprises:
selecting a leaf node of the hierarchical tree; and
generating the sparse representation using the sparse parameter vectors at the selected leaf nodes.

11. The method of claim 1, further comprising:
providing the output representation generated by the highest layer in the sequence to the output layer as the alternative representation.

12. The method of claim 1, further comprising:
providing the input as the input representation for the lowest layer in the sequence.

13. The method of claim 1, further comprising:
training the VTM layers to determine trained values of the sparse parameter vectors and the output parameter vectors of each VTM layer.

14. The method of claim 13, wherein the training the VTM layers comprises training the VTM layers using a plurality of model replicas, wherein each model replica includes an identical replica of the VTM layers and the output layers.

15. A system comprising:
a plurality of vector table machine (VTM) layers, wherein the plurality of VTM layers are configured to receive an input and to collectively process the input to generate an alternative representation of the input, wherein the plurality of VTM layers are arranged in a sequence from a lowest VTM layer to a highest VTM layer, and wherein each VTM layer is configured to:
receive an input representation of the input,
generate a sparse representation of the input representation in accordance with a set of sparse parameter vectors for the VTM layer, and
generate an output representation from the sparse representation in accordance with a set of output parameter vectors for the VTM layer; and
an output layer, wherein the output layer is configured to process the alternative representation of the input to generate an output for the input.

16. The system of claim 15, wherein generating the output representation comprises:
generating the output representation by applying an output function to the sparse representation that maps the sparse representation to the output representation in accordance with the set of output parameter vectors.

17. The system of claim 15, wherein generating the sparse representation comprises:
generating the sparse representation of the input representation by applying a sparsifying function to the input representation that maps the input representation to the sparse representation in accordance with the set of sparse parameter vectors.

18. The system of claim 17, wherein the sparsifying function is a reconstruction function that maps the input representation to the sparse representation, that when combined with the sparse parameter vectors, most closely reconstructs the input representation.

19. The system of claim 18, wherein determining the sparse representation comprises:
determining the k-nearest neighbors to the input representation among the sparse parameters vectors; and
mapping the input representation to the sparse representation that most closely reconstructs the input representation using the k-nearest neighbors.

20. A computer program product encoded on one or more non-transitory computer-storage media, the computer program product comprising instructions that when executed by one or more computers cause the one or more computers to perform operations comprising:
receiving an input;
processing the input through each of a plurality of vector table machine (VTM) layers to generate an alternative representation of the input, wherein the plurality of VTM layers are arranged in a sequence from a lowest VTM layer to a highest VTM layer, and wherein each VTM layer is configured to:
receive an input representation of the input,
generate a sparse representation of the input representation in accordance with a set of sparse parameter vectors for the VTM layer, and
generate an output representation from the sparse representation in accordance with a set of output parameter vectors for the VTM layer; and
processing the alternative representation of the input through an output layer to generate an output for the input.
